(19) United States
(12) Patent Application Publication
(10) Pub. No.: US 2014/0370396 A1
(43) Pub. Date: Dec. 18, 2014

(54) METHOD OF PREPARING LITHIUM PHOSPHATE-BASED SOLID ELECTROLYTE

(71) Applicant: Electronics and Telecommunications Research Institute, Daejeon (KR)

(72) Inventors: Kunyoung KANG, Daejeon (KR); Young-Gi LEE, Daejeon (KR); Kwang Man KIM, Daejeon (KR); Dong Ok SHIN, Daejeon (KR)

(73) Assignee: Electronics and Telecommunications Research Institute, Daejeon (KR)

(21) Appl. No.: 14/246,653

(22) Filed: Apr. 7, 2014

(30) Foreign Application Priority Data
Jun. 14, 2013 (KR) 10-2013-0068261
Dec. 6, 2013 (KR) 10-2013-0151627

(51) Int. Cl. H01M 10/0562; H01M 10/052

(52) U.S. Cl. CPC H01M 10/0562; H01M 10/052; H01M 2300/0068
USPC 429/319

(57) ABSTRACT

A method of preparing a lithium phosphate-based solid electrolyte according to an embodiment of the present invention may include preparing a precursor solution which includes a lithium compound, a phosphate compound, and an aluminum compound, forming a first intermediate by performing a hydrothermal reaction process on the precursor solution, forming a second intermediate by calcinating the first intermediate, and crystallizing the second intermediate. The precursor solution may further include a metal compound or a metalloid compound. The lithium phosphate-based solid electrolyte of the present invention may have high ionic conductivity and high purity.

### CROSS-REFERENCE TO RELATED APPLICATIONS

This U.S. non-provisional patent application claims priority under 35 U.S.C. §119 of Korean Patent Application Nos. 10-2013-0068261, filed on Jun. 14, 2013, and 10-2013-0151627, filed on Dec. 6, 2013, the entire contents of which are hereby incorporated by reference.

### BACKGROUND

The present invention disclosed herein relates to solid electrolytes for a lithium battery, and more particularly, to methods of preparing a lithium phosphate-based solid electrolyte by a hydrothermal reaction.

Interests in lithium batteries have significantly grown as the importance of energy storage and conversion techniques has increased. Lithium batteries may include an anode, a separator, a cathode, and an electrolyte. The electrolyte acts as a medium in which ions may move between the cathode and the anode. Since energy densities of the lithium batteries may be relatively higher than those of other types of batteries and miniaturization and weight reduction of the lithium batteries may be possible, research and development of lithium batteries as power sources of portable electronic devices have been actively conducted. Recently, in line with the improvement of the performance of the portable electronic devices, power consumed in the portable electronic devices has increased. Lithium batteries are required to generate high power. As a result, a lithium battery electrolyte is required to have high ionic conductivity and low electrical conductivity.

The lithium battery electrolyte may include an organic-based liquid electrolyte and an inorganic-based solid electrolyte. The organic-based liquid electrolyte has a lithium salt dissolved therein and is widely used due to high ionic conductivity and stable electrochemical properties. However, a number of issues related to the safety of the organic-based liquid electrolyte have been raised due to its flammability, volatility, and leakage problem. Lithium titanium phosphate may be used as an inorganic-based solid electrolyte. Ionic conductivity and electrical conductivity of the lithium titanium phosphate may be adjusted according to structure and doping status. However, an issue has been raised in which impurities are formed in the lithium titanium phosphate.

### SUMMARY

The present invention provides a method of preparing a phosphate-based solid electrolyte having high purity and ionic conductivity.

The object of the present invention is not limited to the aforesaid, but other objects not described herein will be clearly understood by those skilled in the art from descriptions below.

Embodiments of the present invention provide methods of preparing a lithium phosphate-based solid electrolyte including: preparing a precursor solution which includes a lithium compound, a phosphate compound, an aluminum compound, and a metal compound; forming an intermediate by performing a hydrothermal reaction process on the precursor solution; and crystallizing the intermediate.

In some embodiments, the hydrothermal reaction process may be performed in a temperature range of 100° C. to 240° C. for 2 hours to 48 hours.

In other embodiments, the crystallizing of the intermediate may include forming a solid electrolyte expressed by a chemical formula of Li₁₊ₓAlₓM₂₋ₓ(PO₄)₃, where M is any one of titanium, vanadium, manganese, zirconium, scandium, yttrium, and a combination thereof, and x is 0.1 to 0.6.

In still other embodiments, the crystallizing of the intermediate may be performed in a temperature range of 700° C. to 1,000° C. for 3 hours to 24 hours.

In even other embodiments, the forming of the intermediate further include forming a second intermediate by calcinating the first intermediate, wherein the first intermediate may be prepared by the hydrothermal reaction process, and the crystallizing may be performed on the second intermediate.

In yet other embodiments, the calcinating of the first intermediate may be performed in a temperature range of 300° C. to 700° C. for 2 hours to 6 hours.

In further embodiments, the preparing of the precursor solution may include: preparing a first compound solution by adding the metal compound to a solvent; preparing a second compound solution by adding the aluminum compound to the first compound solution, wherein the second compound solution includes aluminum and metal; preparing a third compound solution by adding the lithium compound to the second compound solution, wherein the third compound solution includes lithium, aluminum, and metal; and adding the phosphate compound to the third compound solution.

In still further embodiments, the precursor solution may further include a metalloid compound.

In other embodiments of the present invention, methods of preparing a lithium phosphate-based solid electrolyte include: preparing a precursor solution which includes a lithium compound, a phosphate compound, an aluminum compound, and a metalloid compound; forming an intermediate by performing a hydrothermal reaction process on the precursor solution; and crystallizing the intermediate.

In some embodiments, the hydrothermal reaction process may be performed in a temperature range of 100° C. to 240° C. for 2 hours to 48 hours.

In other embodiments, the crystallizing of the intermediate may be performed in a temperature range of 500° C. to 1,000° C. for 3 hours to 24 hours.

In still other embodiments, the forming of the intermediate further includes calcinating the intermediate, wherein the calcinating may be performed before the crystallizing.

In even other embodiments, the calcinating of the intermediate may be performed in a temperature range of 300° C. to 600° C. for 2 hours to 6 hours.

In yet other embodiments, the preparing of the precursor solution may include: preparing a first compound solution by adding the metalloid compound to a solvent; preparing a second compound solution by adding the aluminum compound to the first compound solution, wherein the second compound solution includes aluminum and metalloid; preparing a third compound solution by adding the lithium compound to the second compound solution, wherein the third compound solution includes lithium, aluminum, and metalloid; and adding the phosphate compound to the third compound solution.

In further embodiments, the crystallizing of the intermediate may include forming a solid electrolyte expressed by a chemical formula of Liₓ₊₁AlₓM₂₋ₓ(PO₄)₃, where M is any one of germanium, phosphorous, silicon, and a combination thereof, and x is 0.2 to 0.7.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a flowchart illustrating a method of preparing a lithium phosphate-based solid electrolyte according to an embodiment of the present invention;

FIG. 2 is a flowchart illustrating a method of preparing a lithium phosphate-based solid electrolyte according to another embodiment of the present invention;

FIG. 3 is a graph illustrating the result of X-ray diffraction analysis of Comparative Example 2;

FIG. 4 is a graph illustrating the result of X-ray diffraction analysis of Experimental Example 2; and

FIG. 5 is a graph illustrating the results of evaluating impedance characteristics of Experimental Example 2 and Comparative Example 2.

### DETAILED DESCRIPTION OF THE EMBODIMENTS

Preferred embodiments of the present invention will be described below in more detail with reference to the accompanying drawings in order to fully understand the constitution and effect of the present invention. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Those skilled in the art will understand that the present inventive concept can be implemented in an appropriate environment.

In the following description, the technical terms are used only for explaining a specific exemplary embodiment while not limiting the present invention. The terms of a singular form may include plural forms unless referred to the contrary. The meaning of “comprises” and/or “comprising” specifies a property, a region, a fixed number, a step, a process, an element and/or a component but does not exclude other properties, regions, fixed numbers, steps, processes, elements and/or components.

In addition, it will be understood that when an element such as a layer, film, region, or substrate is referred to as being “on” another element, it can be directly on the other element or intervening elements may also be present.

Also, though terms like a first, a second, and a third are used to describe various regions and layers in various embodiments of the present invention, the regions and the layers are not limited to these terms. These terms are used only to discriminate one region or layer from another region or layer. Therefore, a layer referred to as a first layer in one embodiment can be referred to as a second layer in another embodiment. An embodiment described and exemplified herein includes a complementary embodiment thereof. Like reference numerals refer to like elements throughout.

Unless otherwise defined, all terms used herein have the same meaning as commonly understood by one of ordinary skill in the art to which this inventive concept belongs.

Hereinafter, a method of preparing a solid electrolyte according to an embodiment of the present invention will be described.

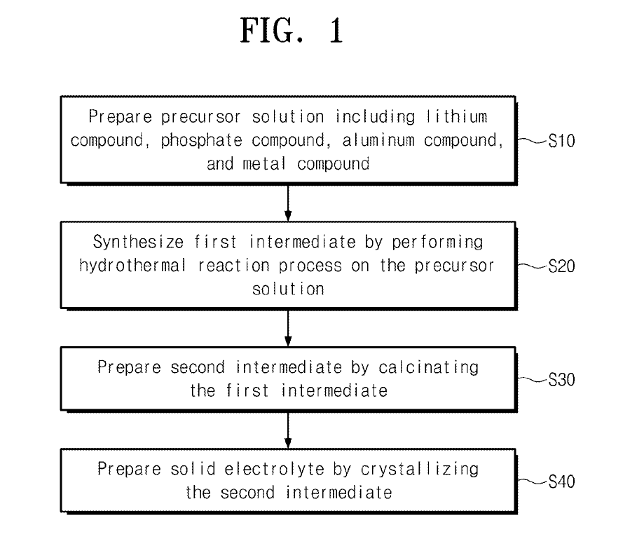

FIG. 1 is a flowchart illustrating a method of preparing a lithium phosphate-based solid electrolyte according to an embodiment of the present invention.

Referring to FIG. 1, a precursor solution including a lithium compound, a phosphate compound, an aluminum compound, and a metal compound may be prepared (S10). A stoichiometric ratio of the added lithium compound, phosphate compound, aluminum compound, and metal compound may be controlled so as to prepare the precursor solution having a compositional formula of Li₁₊ₓAlₓM₂₋ₓ(PO₄)₃ (where 0.1≦x≦0.7, for example, 0.1≦x≦0.6). The metal compound may include any one of titanium, vanadium, manganese, zirconium, scandium, yttrium, and a combination thereof. For example, the metal compound may be a titanium compound. The precursor solution may further include a metalloid compound. The metalloid compound may include any one of germanium, phosphorous, silicon, and a combination thereof. For example, the metalloid compound may include germanium. The lithium compound, phosphate compound, aluminum compound, and metal compound may not include other metals to prevent the inclusion of impurities in the precursor solution. For example, the titanium compound may be added to a solvent to prepare a first compound solution. At least any one selected from the group consisting of a titanium oxysulfate (TiOSO₄) solution, titanium oxysulfate-sulfuric acid hydrate (TiOSO₄-xH₂SO₄-xH₂O), titanium chloride (TiCl₄), and titanium nitride (Ti(NO₃)₄) may be used as the titanium compound. As another example, the titanium compound may be at least one selected from titanium organic compounds such as titanium ethoxide (Ti(C₂H₅)₄), titanium isopropoxide (Ti[OCH(CH₃)₂]₄), titanium methoxide (Ti(OCH₃)₄), and titanium butoxide (Ti[OC(CH₃)₃]₄). The solvent may include any one selected from the group consisting of distilled water, alcohol, and a mixture thereof.

The aluminum compound may be added to the first compound solution. The aluminum compound may include any one selected from the group consisting of an aluminum organic compound, an aluminum oxide, and an aluminum hydrate. Carbon, oxygen, and hydrogen that are included in the aluminum compound may be removed during a calcination process. The calcination process will be described later in S30. For example, the aluminum compound may be aluminum sulfate (Al₂(SO₄)₃), aluminum acetate ((CH₃CO₂)₂AlOH), aluminum hydroxide (Al(OH)₃), aluminum nitrate hydrate (Al(NO₃)₃.9H₂O), aluminum isopropoxide (Al[OCH(CH₃)₂]₃), aluminum butoxide (Al[OC(CH₃)₃]₄), or aluminum methoxide (Al(OCH₃)₄). The aluminum compound and a titanium solution may be mixed to form a second compound solution. The second compound solution may include aluminum and metal (e.g., titanium). In this case, a surfactant may be further added to the titanium solution to which aluminum is added. As another example, the surfactant may be added to the above-described solvent or titanium solution. The sequence of adding the surfactant is not limited thereto and may be varied. Particles included in the second compound solution may be uniformly dispersed and may have a uniform size by the surfactant. The surfactant may be any one selected from the group consisting of a non-ionic surfactant (e.g., a copolymer of ethylene oxide and propylene oxide, a glycerin fatty acid ester, a sorbitan fatty acid ester, ethoxylated linear alcohol, or ethoxylated alkyl phenol), a cationic surfactant (e.g., an ammonium salt or amine salt), an anionic surfactant (e.g., a carboxylic acid salt), and a mixture thereof.

The lithium compound may be added to the second compound solution. The lithium compound may be mixed with the second compound solution to prepare a third compound solution. The third compound solution may include lithium, aluminum, and titanium. The lithium compound may include at least one selected from the group consisting of Li₂CO₃, LiOH, Li₂O, LiNO₃, and a hydrate thereof.

The phosphate compound may be added to the third compound solution. The phosphate compound and the third compound solution may be mixed to prepare a precursor solution. For example, H₃PO₄ or (NH₄)₂HPO₄ may be used as the phosphate compound. The precursor solution may include lithium, aluminum, metal (e.g., titanium), and phosphate.

A first intermediate may be synthesized from the precursor solution by a hydrothermal reaction process (S20). The expression “hydrothermal reaction” denotes a synthesis or modification reaction that is performed using water or an aqueous solution under conditions of high temperature and high pressure. The precursor solution may be provided to a autoclave. The hydrothermal process of the precursor solution may be performed in a temperature range of 100° C. to 240° C., for example, 110° C. to 200° C. In the case that the hydrothermal process is performed at a temperature lower than 100° C., the first intermediate may not be synthesized. In the case in which the hydrothermal process is performed at a temperature higher than 240° C., the first intermediate may be formed to have a non-uniform shape or size. The hydrothermal reaction may be performed for 2 hours to 48 hours, for example, 2 hours to 30 hours. In the case that the hydrothermal reaction is performed on the precursor solution for less than 2 hours, the first intermediate may not be synthesized or the size of the synthesized first intermediate may be excessively small. In the case in which the hydrothermal reaction of the precursor solution is performed for 48 hours or more, the first intermediate may be synthesized to have an excessively large particle size. The hydrothermal reaction of the first intermediate may be performed in the autoclave.

The first intermediate prepared after the hydrothermal process may be in a solution state. The first intermediate may be dried to be in a solid state. The first intermediate may be partially agglomerated. The first intermediate in a solid state may be ground so that the first intermediate may be dispersed. The grinding process may be performed by a mechanical method or a hand mill For example, the first intermediate may be ground using an agate mortar or a ball mill As another example, the preparation process of the first intermediate may be omitted.

A second intermediate may be prepared by calcinating the first intermediate (S30). The expression “calcination” may denote that any material is heated to remove a volatile component which is included in the material. The second intermediate may have a lower impurity concentration than the first intermediate. The first intermediate may be calcinated in a temperature range of 300° C. to 700° C. In the case that the calcination process of the first intermediate is performed at a temperature of less than 300° C., impurities may remain in the first intermediate. In the case in which the calcination process of the first intermediate is performed at a temperature of higher than 700° C., the second intermediate may have an excessively large particle size. The calcination process may be performed at a heating rate of 1° C./min to 10° C./min When the heating rate is less than 1° C./min, an efficiency of the calcination process may be low. When the heating rate is greater than 10° C./min, impurities in the first intermediate may not be removed. The calcination of the first intermediate may be performed for 2 hours to 6 hours. The calcination of the first intermediate may be performed in a heat treatment crucible. After the calcination process, the prepared second intermediate may be separated from the heat treatment crucible. A second intermediate prepared by a solid phase method or melting method may be difficult to be separated from the heat treatment crucible. The second intermediate of the present invention may be easily separated from the heat treatment crucible. As a result, the heat treatment crucible may be repeatedly used. The second intermediate separated from the heat treatment crucible may be ground using an agate mortar or a ball mill

A solid electrolyte may be prepared by crystallizing the second intermediate (S40). For example, the first intermediate may be heat treated in a temperature range of 700° C. to 1,000° C. so as to form the second intermediate. In the case that the crystallization process of the first intermediate is performed at a temperature of less than 700° C., the solid electrolyte may have low crystallinity. In the case in which the crystallization process of the first intermediate is performed at a temperature of greater than 1,000° C., the solid electrolyte may have an excessively large particle size. The crystallization process may be performed at a heating rate of 1° C./min to 10° C./min When the heating rate is less than 1° C./min, an efficiency of the crystallization process may be low. When the heating rate is greater than 10° C./min, the second intermediate may have low crystallinity. The crystallization process of the first intermediate may be performed for 3 hours to 24 hours. In the case that the crystallization process of the first intermediate is performed for less than 3 hours, the solid electrolyte may not be formed or the solid electrolyte may have low crystallinity. In the case in which the crystallization process of the first intermediate is performed for greater than 24 hours, the solid electrolyte may have excessively large crystal and particle sizes. Therefore, the solid electrolyte prepared from the second intermediate may have a low impurity content and high ionic conductivity.

The solid electrolyte prepared according to the present invention may be expressed by a chemical formula of Li₁₊ₓAlₓM₂₋ₓ(PO₄)₃, where M is a metal and x may be 0.7 or less, for example, 0.1 to 0.6. For example, the solid electrolyte may be lithium aluminum titanium phosphate. When x is less than 0.1, the solid electrolyte may have excessively low ionic conductivity. When x is greater than 0.6, an amount of impurities included in the solid electrolyte may be large. The solid electrolyte of the present invention may have a pure phase. The expression “pure phase” may denote that foreign matter is not detected in a powder X-ray diffraction pattern. For example, the solid electrolyte may include 1 ppm or less of a magnetic metal compound (e.g., iron (Fe), Chromium (Cr), and/or nickel (Ni)). As another example, the solid electrolyte may have an impurity (e.g., AlPO₄, TiP₂O₇, and/or Li₄P₂O₇) content of 1 wt % or less. The solid electrolyte of the present invention may have an average particle diameter of 200 nm to 2 μm.

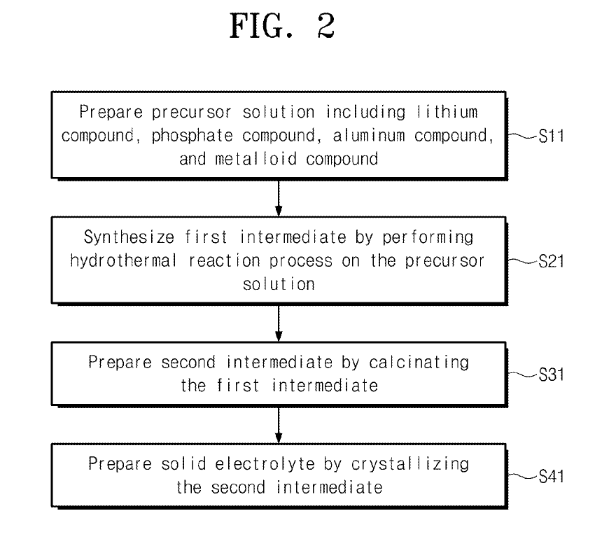

FIG. 2 is a flowchart illustrating a method of preparing a lithium phosphate-based solid electrolyte according to another embodiment of the present invention. Hereinafter, descriptions overlapping with the aforementioned descriptions will be omitted.

Referring to FIG. 2, a precursor solution including a lithium compound, a phosphate compound, an aluminum compound, and a metalloid compound may be prepared (S11). A stoichiometric ratio of the added lithium compound, phosphate compound, aluminum compound, and metalloid compound may be controlled so as to prepare a precursor solution having a compositional formula of Li₁₊ₓAlₓM₂₋ₓ(PO₄)₃ (where 0.2≦x≦0.7 and M is the metalloid compound). The metalloid may include at least one of germanium, silicon, phosphorous, and a combination thereof. For example, the metalloid may be germanium. For example, a germanium compound may be added to a solvent in order to prepare a first compound solution. For example, the germanium compound may include any one selected from germanium organic compounds such as germanium chloride (GeCl), germanium ethoxide (Ge(OC₂H₅)₄), germanium isopropoxide (Ge[OCH(CH₃)₂]₃), and germanium methoxide (Ge(OCH₃)₄). A solvent may be any one selected from the group consisting of distilled water, alcohol, and a mixture thereof. The aluminum compound may be added to the first compound solution. The aluminum compound may be mixed with a germanium solution to form a second compound solution. The second compound solution may include aluminum and metalloid (e.g., germanium). In this case, a surfactant may be further added to the first compound solution to which aluminum is added. The sequence of adding the surfactant is not limited thereto and may be varied. Particles included in the second compound solution may be uniformly dispersed and may have a more uniform size by the addition of the surfactant. The lithium compound may be added to the second compound solution. The lithium compound may be mixed with the second compound solution to prepare a third compound solution. The third compound solution may include lithium, aluminum, and metalloid (e.g., germanium). The phosphate compound may be added to the third compound solution. The phosphate compound may be mixed with the third compound solution to prepare a precursor solution. An aluminum compound, a surfactant, a lithium compound, and a phosphate compound, which are the same or similar to those described in the example of S10, may be used as the aluminum compound, surfactant, lithium compound, and phosphate compound.

A hydrothermal process may be performed on the precursor solution to synthesize a first intermediate (S21). The first intermediate may be in a solution state. For example, the hydrothermal reaction of the first intermediate may be performed in a temperature range of 100° C. to 240° C., for example, 110° C. to 200° C. A calcination process may be performed at a heating rate of 1° C./min to 10° C./min The hydrothermal reaction may be performed for 2 hours to 48 hours, for example, 2 hours to 30 hours. The hydrothermal process of the present embodiment may be the same or similar to the hydrothermal process described in the example of S20. After the hydrothermal process, the prepared first intermediate may be in a solution state. The first intermediate may be dried to be in a solid state. The first intermediate in a solid state may be ground.

A second intermediate may be prepared by calcinating the first intermediate (S31). The second intermediate may have a lower impurity concentration than the first intermediate. The first intermediate may be calcinated in a temperature range of 300° C. to 600° C. In the case that the calcination process of the first intermediate is performed at a temperature of less than 300° C., impurities may remain in the first intermediate. In the case in which the calcination process of the first intermediate is performed at a temperature of greater than 600° C., the second intermediate may have an excessively large particle size. The calcination of the first intermediate may be performed for 2 hours to 6 hours. The second intermediate may be ground after the calacination process. The calcination of the first intermediate may be the same or similar to the calcinations process described in the example of S30.

A solid electrolyte may be prepared by crystallizing the second intermediate (S41). For example, the second intermediate may be heat treated in a temperature range of 500° C. to 1,000° C., for example, 500° C. to 800° C. so as to form the solid electrolyte. In the case that the crystallization process of the second intermediate is performed at a temperature of less than 500° C., the solid electrolyte may have low crystallinity. In the case in which the crystallization process of the second intermediate is performed at a temperature of greater than 1,000° C., the solid electrolyte may have an excessively large particle size. The second intermediate including germanium may be crystallized at a lower temperature (e.g., 500° C. to 800° C.) than the second intermediate including the metal (e.g., titanium) described in the example of FIG. 1. The crystallization process may be performed at a heating rate of 1° C./min to 10° C./min The crystallization process of the second intermediate may be performed for 3 hours to 24 hours. In the case that the crystallization process of the second intermediate is performed for less than 3 hours, the solid electrolyte may not be formed or the solid electrolyte may have low crystallinity. In the case in which the crystallization process of the second intermediate is performed for greater than 24 hours, the solid electrolyte may be non-uniform or may have an excessively large crystal size.

The solid electrolyte prepared according to the present invention may be expressed by Li₁₊ₓAlₓM₂₋ₓ(PO₄)₃, where M is a metalloid and x may be 0.2 to 0.7. When x is less than 0.2, the solid electrolyte may have excessively low ionic conductivity. When x is greater than 0.7, an amount of impurities included in the solid electrolyte may be large. For example, the solid electrolyte may be lithium aluminum germanium phosphate. The solid electrolyte of the present embodiment may have a pure phase. The solid electrolyte of the present embodiment, which is prepared by the hydrothermal method, may have high ionic conductivity.

Hereinafter, the preparation of the solid electrolyte according to the present invention and the results of the characterization of the solid electrolyte will be described in more detail with reference to experimental examples of the present invention.

Preparation of Lithium Aluminum Titanium Phosphate

### EXPERIMENTAL EXAMPLE 1

### Preparation of Li_{1.3} Al_{0.3}T_{1.7}(PO₄)₃>

(Preparation of Precursor Solution)

Stoichiometrically calculated amounts of Ti[OCH(CH₃)₂]₄, LiOH.H₂O, H₃PO₄, and Al(NO₃)₃.9H₂O were prepared. The prepared Ti[OCH(CH₃)₂]₄ was added to distilled water. A titanium solution was prepared by stirring the distilled water having Ti[OCH(CH₃)₂]₄ added thereto for 2 hours. Al(NO₃)₃.9H₂O was added to the titanium solution. An aluminum titanium solution was prepared by stiffing the titanium solution having Al(NO₃)₃.9H₂O added thereto for 1 hour. LiOH.H₂O was added to the titanium aluminum solution. A lithium aluminum titanium solution was prepared by stirring the aluminum titanium solution having LiOH.H₂O added thereto for 1 hour. H₃PO₄ was added to the lithium aluminum titanium solution. A precursor solution was prepared by stirring the lithium aluminum titanium solution having H₃PO₄ added thereto for 1 hour.

(Hydrothermal Reaction and Drying)

The precursor solution was put in a 200 ml Teflon container. The Teflon container, in which the precursor solution was put, was sealed and an autoclave including the precursor solution was then prepared. The precursor solution in the autoclave was heat treated at 180° C. for 12 hours to prepare a first intermediate. The first intermediate was stirred at 90° C. after it had been stirred at 300 rpm for 1 hour. The stirring was performed until the first intermediate became solid-state powder. After the stirring, the first intermediate was dried in an oven at 80° C. for 12 hours or more. The drying of the first intermediate was performed until moisture was removed.

(Calcination and Crystallization)

The first intermediate was heated from room temperature to 450° C. at a heating rate of 5° C./min A second intermediate was prepared by calcinating the first intermediate at 450° C. for 3 hours. Thereafter, the second intermediate was cooled. The second intermediate was ground by a ball milling process using alcohol and zirconia balls. The second intermediate ground was dried at 80° C. for 12 hours to remove the alcohol form the second intermediate. The second intermediate was heated to 900° C. at a heating rate of 5° C./min. The second intermediate was heat treated at 900° C. for 6 hours. As a result, lithium aluminum titanium phosphate having a chemical formula of Li_{1.3}Al_{0.3}Ti_{1.7}(PO₄)₃ was prepared.

### COMPARATIVE EXAMPLE 1

Lithium aluminum titanium phosphate (Li_{1.3}Al_{0.3}Ti_{1.7}(PO₄)₃) may be prepared. However, in the present example, the preparation of a precursor solution, the preparation of a first intermediate by a hydrothermal reaction, and the preparation of a second intermediate by a calcination process may be omitted. For example, lithium carbonate (Li₂CO₃), H₃PO₄, Ti[OCH(CH₃)₂]₄, and Al(NO₃)₃.9H₂O were mixed for 2 hours by ball milling using alcohol to prepare a mixture. The mixture was heat treated at 80° C. for 2 hours to remove the alcohol from the mixture. The mixture was crystallized by using the same conditions as in Experimental Example 1 to prepare Comparative Example 1 (Li_{1.3}Al_{0.3}Ti_{1.7}(PO₄)₃).

Characterization of Solid Electrolyte

### EXPERIMENTAL EXAMPLE 2

A 1 mm thick solid electrolyte pellet was prepared by pressing lithium aluminum titanium phosphate prepared in Experimental Example 1. The solid electrolyte pellet was heated from room temperature to 900° C. at a heating rate of 5° C./min, and heat treated at 900° C. for 3 hours. A copper layer was formed on each side of the solid electrolyte pellet by a thermal deposition method. A copper foil layer was attached to each copper layer. As a result, a cell was prepared in which the copper foil, the copper layer, the solid electrolyte pellet, the copper layer, and the copper foil were sequentially stacked. Alternating current (AC) impedance of the solid electrolyte pellet was measured using a frequency response analyzer (Solatron HF 1225) in an AC frequency range of 10⁻¹ to 10⁶ Hz. Ionic conductivity of the solid electrolyte was calculated from the measured AC impedance.

### COMPARATIVE EXAMPLE 2

A solid electrolyte pellet of Comparative Example 2 was formed by performing the same processes as in Example 2 on the lithium aluminum titanium phosphate of Comparative Example 1. AC impedance of Comparative Example 2 was measured in the same manner as in Experimental Example 2.

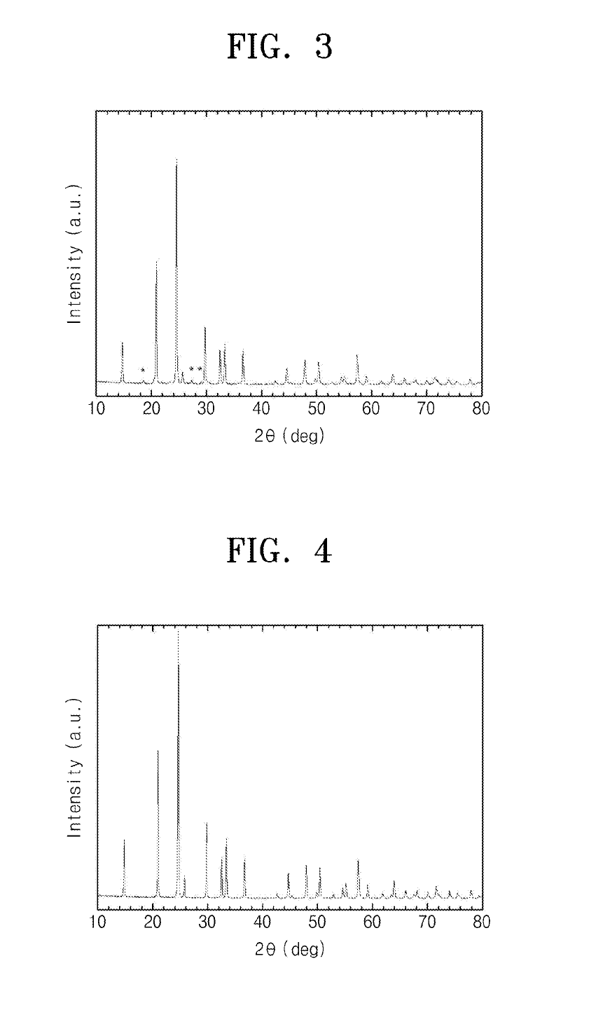

FIG. 3 is a graph illustrating the result of X-ray diffraction analysis of Comparative Example 2. FIG. 4 is a graph illustrating the result of X-ray diffraction analysis of Experimental Example 2.

Referring to FIG. 3, with respect to Comparative Example 2, peaks (*) of LiTiPO₅ were observed along with peaks of lithium aluminum titanium phosphate. Thus, it may be understood that Comparative Example 2 further included LiTiPO₅ as an impurity.

Referring to FIG. 4, different from Comparative Example 2, the peaks of LiTiPO₅ were not observed in Experimental Example 2. Thus, it may be understood that Experimental Example 2 did not include impurities. According to Experimental Example 2, a uniformly mixed first intermediate may be prepared by a hydrothermal reaction. With respect to a second intermediate prepared from the first intermediate, a lithium element, an aluminum element, a titanium element, and a phosphate element, which were included in the second intermediate, may be uniformly distributed. As a result, with respect to Example 2, impurities, such as LiTiPO₅, may not be formed. Also, impurities included in the first intermediate may be evaporated by the calcination process of the first intermediate. The lithium aluminum titanium phosphate of Experimental Example 2, which was prepared via the first and second intermediates may have a pure phase in which impurities were not included.

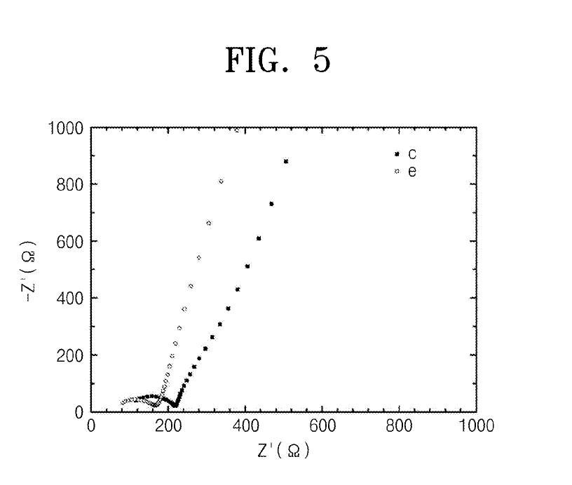

FIG. 5 is a graph illustrating the results of evaluating impedance characteristics of Experimental Example 2 and Comparative Example 2.

Referring to FIG. 5, Experimental Example 2(e) had lower internal resistance than Comparative Example 2(c). Therefore, the lithium aluminum titanium phosphate of Experimental Example 2(e) may have higher ionic conductivity than the aluminum titanium phosphate of Comparative Example 2(c).

Table 1 represents ionic conductivities of the lithium aluminum titanium phosphates of Experimental Example 2 and Comparative Example 2. The ionic conductivities were calculated from the results of the impedance measurement of Experimental Example 2 and Comparative Example 2.

TABLE 1

| | Experimental Example 2 | Comparative Example 2 |
|---|---|---|
| Ionic conductivity | 5.55 × 10⁻⁴ S/cm | 2.63 × 10⁻⁵ S/cm |

Experimental Example 2(e) exhibited an ionic conductivity of 5.55×10⁻⁴ S/cm, and Comparative Example 2(c) exhibited an ionic conductivity of 2.63×10⁻⁵ S/cm. It may be confirmed that Experimental Example 2(e) had higher ionic conductivity than Comparative Example 2(c). Since the purity of the lithium aluminum titanium phosphate of Experimental Example 2(e) was high, the lithium aluminum titanium phosphate of Experimental Example 2(e) may have high ionic conductivity.

According to the present invention, a uniformly mixed first intermediate may be prepared by a hydrothermal reaction. With respect to a second intermediate prepared from the first intermediate, a lithium element, an aluminum element, a titanium element, and a phosphate element may be uniformly distributed in the second intermediate. A solid electrolyte of the present invention may be prepared by a crystallization process of the second intermediate. The solid electrolyte may have high ionic conductivity and high purity. The solid electrolyte may have a lower impurity content by a calcination process.

While preferred embodiments of the present invention has been particularly shown and described with reference to the accompanying drawings, it will be understood by those of ordinary skill in the art that various changes in form and details may be made therein without departing from the spirit and scope of the present invention as defined by the following claims.

What is claimed is:

1. A method of preparing a lithium phosphate-based solid electrolyte, the method comprising:
preparing a precursor solution which includes a lithium compound, a phosphate compound, an aluminum compound, and a metal compound;
forming an intermediate by performing a hydrothermal reaction process on the precursor solution; and
crystallizing the intermediate.

2. The method of claim 1, wherein the hydrothermal reaction process is performed in a temperature range of 100° C. to 240° C. for 2 hours to 48 hours.

3. The method of claim 1, wherein the crystallizing of the intermediate comprises forming a solid electrolyte expressed by a chemical formula of Li₁₊ₓAlₓM₂₋ₓ(PO₄)₃,
where M is any one of titanium, vanadium, manganese, zirconium, scandium, yttrium, and a combination thereof, and x is 0.1 to 0.6.

4. The method of claim 1, wherein the crystallizing of the intermediate is performed in a temperature range of 700° C. to 1,000° C. for 3 hours to 24 hours.

5. The method of claim 1, wherein the forming of the intermediate further comprises forming a second intermediate by calcinating the first intermediate,
wherein the first intermediate is prepared by the hydrothermal reaction process, and
the crystallizing is performed on the second intermediate.

6. The method of claim 5, wherein the calcinating of the first intermediate is performed in a temperature range of 300° C. to 700° C. for 2 hours to 6 hours.

7. The method of claim 1, wherein the preparing of the precursor solution comprises:
preparing a first compound solution by adding the metal compound to a solvent;
preparing a second compound solution by adding the aluminum compound to the first compound solution, wherein the second compound solution includes aluminum and metal;
preparing a third compound solution by adding the lithium compound to the second compound solution, wherein the third compound solution includes lithium, aluminum, and metal; and
adding the phosphate compound to the third compound solution.

8. The method of claim 1, wherein the precursor solution further comprises a metalloid compound.

9. A method of preparing a lithium phosphate-based solid electrolyte, the method comprising:
preparing a precursor solution which includes a lithium compound, a phosphate compound, an aluminum compound, and a metalloid compound;
forming an intermediate by performing a hydrothermal reaction process on the precursor solution; and
crystallizing the intermediate.

10. The method of claim 9, wherein the hydrothermal reaction process is performed in a temperature range of 100° C. to 240° C. for 2 hours to 48 hours.

11. The method of claim 9, wherein the crystallizing of the intermediate is performed in a temperature range of 500° C. to 1,000° C. for 3 hours to 24 hours.

12. The method of claim 9, wherein the forming of the intermediate further comprises calcinating the intermediate,
wherein the calcinating is performed before the crystallizing.

13. The method of claim 12, wherein the calcinating of the intermediate is performed in a temperature range of 300° C. to 600° C. for 2 hours to 6 hours.

14. The method of claim 9, wherein the preparing of the precursor solution comprises:
preparing a first compound solution by adding the metalloid compound to a solvent;
preparing a second compound solution by adding the aluminum compound to the first compound solution, wherein the second compound solution includes aluminum and metalloid;
preparing a third compound solution by adding the lithium compound to the second compound solution, wherein the third compound solution includes lithium, aluminum, and metalloid; and
adding the phosphate compound to the third compound solution.

15. The method of claim 9, wherein the crystallizing of the intermediate comprises forming a solid electrolyte expressed by a chemical formula of Li₁₊ₓAlₓM₂₋ₓ(PO₄)₃,
where M is any one of germanium, phosphorous, silicon, and a combination thereof, and x is 0.2 to 0.7.
